(19) United States
(12) Patent Application Publication
(10) Pub. No.: US 2019/0188580 A1
(43) Pub. Date: Jun. 20, 2019

(54) SYSTEM AND METHOD FOR AUGMENTED MEDIA INTELLIGENCE

(71) Applicant: PAYPAL, INC., San Jose, CA (US)

(72) Inventors: Anita P. Rao, Cupertino, CA (US); Swati Atit Shah, Dublin, CA (US)

(21) Appl. No.: 15/844,257

(22) Filed: Dec. 15, 2017

(51) Int. Cl. G06N 5/04; G06F 17/30; G06F 15/18

(52) U.S. Cl. CPC G06N 5/04; G06F 15/18; G06F 17/30994

(57) ABSTRACT

Aspects of the present disclosure involve systems, methods, devices, and the like for augmented media intelligence using data analytics, machine learning and data visualization. In one embodiment, a system is introduced that can retrieve real-time data from social media platforms to perform augmented media intelligence analytics. The augmented media system is designed to generate reports/actionable insights for user visualization on an interactive user interface, where the reports are based in part on the user social currency.

### TECHNICAL FIELD

The present disclosure generally relates to intelligent information visualization for an enterprise system, and more specifically, to data analytics and data visualization for augmented media intelligence.

### BACKGROUND

Today up to one third of the world's population is on a social media platform including social applications, blogs, videos, online news, etc. This data can produce up to 2.5 Exabyte of data per day. Oftentimes, this data is monitored so that if a public relationship crisis or other significant event occurs, campaigns and media events can be established in response to such crisis. Monitoring the data, however, may be a challenge due to the volume, quality, veracity and speed of data received. Thus, it would be beneficial to have the capability to monitor and listen to the media events by filtering the noise so that appropriate campaigns and media responses can be created.

### BRIEF DESCRIPTION OF THE FIGURES

FIG. 1 illustrates a flowchart for generating augmented media intelligence.

FIG. 2 illustrates a block diagram illustrating a data analytics and visualization system for augmented media intelligence.

FIG. 3 illustrates monitoring and analysis using augmented media intelligence.

FIGS. 4A-4C illustrate exemplary interactive interfaces generated by the data analytics and visualization system.

FIG. 5 illustrates a flow diagram illustrating operations for data analytics and visualization for augmented media intelligence.

FIG. 6 illustrates an example block diagram of a computer system suitable for implementing one or more devices of the communication systems of FIGS. 1-5.

Embodiments of the present disclosure and their advantages are best understood by referring to the detailed description that follows. It should be appreciated that like reference numerals are used to identify like elements illustrated in one or more of the figures, whereas showings therein are for purposes of illustrating embodiments of the present disclosure and not for purposes of limiting the same.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Aspects of the present disclosure involve systems, methods, devices, and the like for augmented media intelligence using Artificial Intelligence, Machine Learning, Natural Language Processing, data analytics and data visualization. In one embodiment, a system is introduced that can retrieve real-time data from social media platforms to perform augmented media intelligence analysis and take real time actions if necessary. The augmented media system is designed to generate dashboards, and reports for user visualization on an interactive user interface, where the reports are based in part on the user social currency.

Enterprise media generally relates to all forms of digital media including social media, blogs, videos, online news, etc. In particular, enterprise social media relates to a category of online communications which includes corporate based input, interactions, content-sharing, and collaboration amongst various venues. The data generated can be very useful in understanding responses to product releases, content-sharing, strategy, response to crisis, etc. However, the data is very voluminous and is not always structured. Therefore, a method for ingesting large volumes of multifaceted data, categorizing and classifying it, and understanding its impact is important.

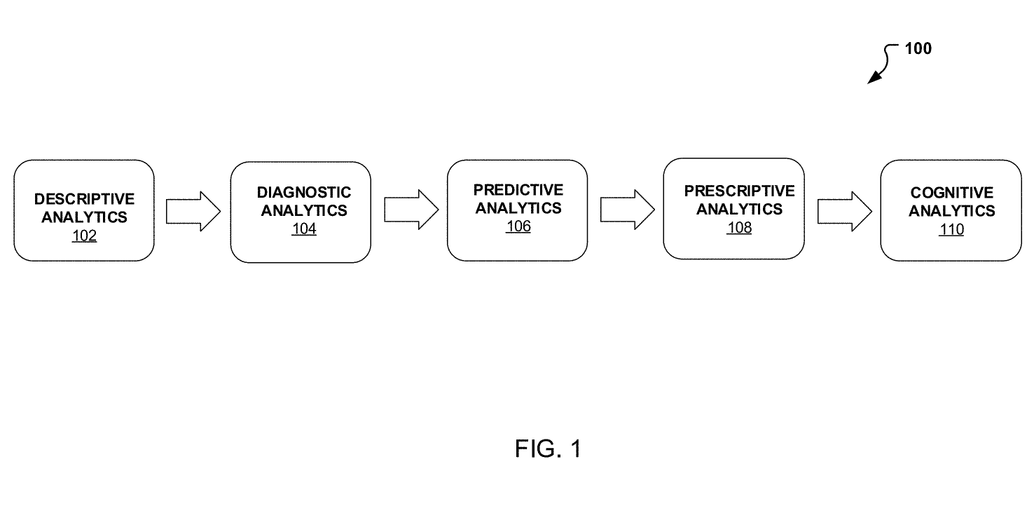

Conventionally, in social media enterprise, such data can be analyzed using one or more of five social media available. FIG. 1 presents the five media analytic methods available. In particular, FIG. 1 illustrates a flowchart 100 for generating augmented media intelligence by integrating not only the five media analytic methods, but also an adding a fifth Cognitive media analytical method. Further, FIG. 1 presents flowchart 100 that enables the use of all five media analytic methods to enable augmented media intelligence in a self-sustaining ecosystem.

As illustrated, data analytics can begin with descriptive analytics 102. Descriptive analytics is the analysis of events after they have taken place. For example, media posts, mentions, views, comments, page views, and the like, can be analyzed to decipher what happened based on the data retrieved. The data retrieved may derive from one or more serves, devices, systems, clouds, etc., which can include enterprise media. Next, the data retrieved may be analyzed using diagnostic analytics 104. Diagnostic analytics 104 are useful in determining why an event, response, comment, or other occurred. Diagnostic analytics 104 involves learning based on the monitoring why a result occurred and what did/did not work. Because the analytics includes learning from the data retrieved, machine learning algorithms and even statistics in determining correlations between media sentiments and the business impact on key performance indicators (KPIs). Upon retrieving and analyzing the, what and why of the data, predictive analytics 106 may be performed to determine the what/why will happen in future. Predictive analytics 106 is the analysis of the data retrieved to predict future events. For example, predictive analytics 106 may be used to predict the media impact of a given campaign. That is to say, using historical data, media responses, and large data analysis, predictions can be made as to how a product release, post, announcement, or campaign will be received in media and might translate into a future event. Next, prescriptive analytics 108 may be performed on the enterprise data. Prescriptive analytics 108 extends the analysis of historical trends from the data retrieved to discover trends and patterns of behavior in the data. The patterns and trends identified can then be used to provide insight and/or prescribe future events, responses, postings, etc. For example, prescriptive analysis 108 may be used to recommend a future campaign for the business. Finally, the last of the fifth social media analytics, Cognitive Analytics 110 continues the analysis by taking into account the reason for a user's behavior and use the analysis to decipher the emotional, psychical, intellectual, and subconscious reasons for the same. The information gathered from the cognitive analytics 110 can then be used for example, to aid marketers in delivering real-time personalized experiences to customers.

Note that the descriptive and diagnostic analytics 102,104 can be categorized as reactive analytics as a “look back” at the data retrieved from the media sources is analyzed. Alternatively, the predictive, prescriptive analytics, and cognitive analytics 106,108, and 110 can be categorized as proactive analytics as a “look ahead” on how to respond based on the data retrieved is considered.

FIG. 1 illustrates data analytics that can occur from enterprise data, however, due to the volume, veracity, and speed of data, data ingestion is possible through the creation of a media intelligence platform which can deliver this capability in real-time. For example, in descriptive analytics, the probability of an event occurring is possible with real-time listening and monitoring of the enterprise data. As another example, cognitive analytics may be performed using the real-time data to predict and analyze patterns in the data.

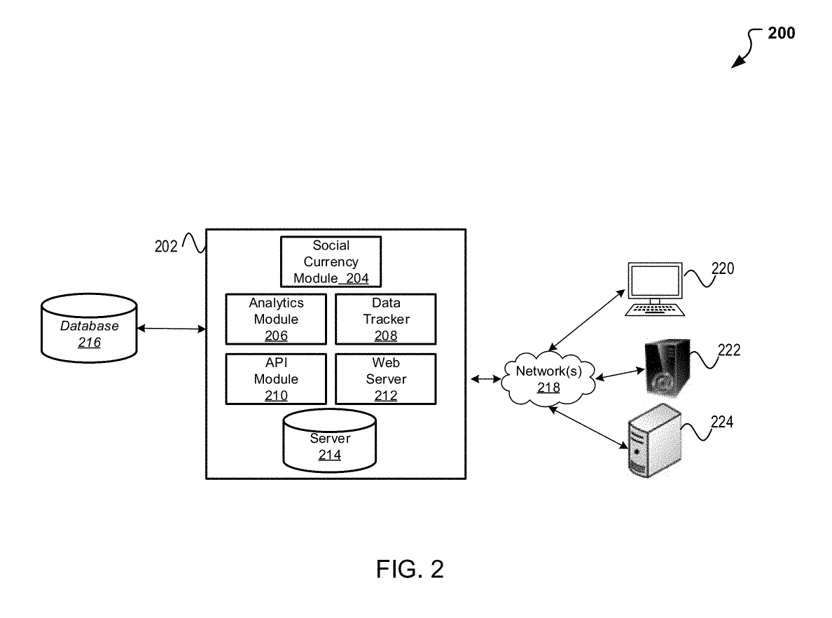

FIG. 2 illustrates a system designed to function as a media intelligence platform 200 for real-time data analytics. In particular, FIG. 2 illustrates a block diagram illustrating a data analytics and visualization system for augmented media intelligence. The media intelligence platform 200 can include at least a database(s) 216, an augmented media system 202, and/or external peripherals 220-224. The augmented media system 202 can be a system design to enable the real-time presentation, analytics, and visualization of media data. The augmented media system can include a social currency module 204, analytics module 206, data tracker 208, Application Programming Interface (API) 210, web server 212, and server 214. The augmented media system 202 can perform the real-time analytics included in FIG. 1 using at least analytics module 206. In particular, descriptive analytics 102, diagnostics analytics 104, predictive analytics 106 and prescriptive analytics can occur on the analytics module 206 for monitoring, responding, predicting and prescribing how to respond to a campaign, event, feedback, etc. etc. To perform such analytics, the analytics module 206 may include an artificial intelligence engine with natural language processing capabilities in order to respond to complex queries and perform the real-time analytics for the augmented media system 202.

As illustrated, the augmented media system 202 can also include an application programming interface (API) module 210. The API module 210 can act as an interface with one or more database(s) 216. In addition, API module can enable data tracker module 208 to retrieve data from database nodes and/or monitor movements of the data across the database nodes and other media data deriving from the network(s) 218. In some embodiments, the API module 210 may establish a universal protocol for communication of data between the API module 210 and each of the database(s) 216 and/or nodes. In other embodiments, the API module 210 may generate a data request (e.g., a query) in any one of several formats corresponding to the database 216. Based on a request for data intending for a specific database from the data tracker module 208, the API module 210 may convert the request to a data query in a format (e.g., an SQL query, a DMX query, a Gremlin query, a LINQ query, and the like) corresponding to the specific database. Additionally, the server 214 may store, and retrieve data previously stored for use with the analytics module 206.

In some embodiments, the augmented media system 202 can communicate with external devices, components, peripherals 220-224 via API module 210. API module 210 can, therefore, act as an interface between one or more networks 218 (and systems/peripherals 220-224) and augmented media system 202. Peripherals 220-224 can include networks, servers, systems, computers, devices, clouds, and the like which can be used to communicate digital media. For example, peripherals 220-224 can be used to communicate digital media including but not limited to, social media, blogs, videos, online news, etc. The data communicated (e.g., scraped) from the web over the network 218 can be used for the real-time presentation, analytics, and visualization of media data.

The augmented media system 202, as indicated, includes a server 214 and network 218 and thus can be a network-based system which can provide the suitable interfaces that enable the communication using various modes of communication including one or more networks 218. The augmented media system 202 can include the web server 212, and API module 210 to interface with the at least one server 214. It can be appreciated that web server 212 and the API module 210 may be structured, arranged, and/or configured to communicate with various types of devices, third-party devices, third-party applications, client programs, mobile devices and other peripherals 220-224 and may interoperate with each other in some implementations.

Web server 212 may be arranged to communicate with other devices and interface using a web browser, web browser toolbar, desktop widget, mobile widget, web-based application, web-based interpreter, virtual machine, mobile applications, and so forth. Additionally, API module 210 may be arranged to communicate with various client programs and/or applications comprising an implementation of an API for network-based system and augmented media system 202. For example the augmented media system 202 may be designed to provide an application with an interactive web interface, platform, and/or browser by using the web server 212. The interactive web interface, may enable a user to view different reports or performance metrics related to a particular organization group. For example, a Marketing or Product Group within a corporation may benefit from real-time media data that can be tailored to provide plots, statistics, diagrams, and other information that can be used to market a new campaign or track product performance. In particular, in one embodiment, a marketing team for example may use the augmented media system to publish and monitor content across social media channels driving campaign activation and to provide insights on trends and audience engagement based on the content published. Therefore, in this embodiment, the marketing team can use the augmented media system 202 to actively monitor and listen to the social media traffic (internally and externally) and measure and analyze the performance of a campaign. As another example, the interactive web interface may be used by the customer service team to service and answer questions from customers and prospective clients. Still in another example, the interactive web interface may be used to correlate a campaign to the call volume at customer service centers. The correlation data can be used to predict, forecast, and prescribe staffing at customer service centers.

In some embodiments, understanding the client and/or customer is important for determining how to respond and/or present information. Therefore, in some embodiments, the augmented media system 202 can also include the social currency module 204. The social currency module 204 is a component designed to aid in providing hyper-personalized content to one or more users in real-time (at the right time) using augmented media system 202. In general, social currency can be described as the response and resources that arise from content and information shared about a brand or other through social networks, communities, and other social media. Therefore, the social currency module 204 is a component that evaluates social media users and organizations beneficiating from social media to provide hyper-personalized content in real time in an effort to deliver content that can help increase a user's propensity to engage in a purchase or respond to a product, campaign, or other. The social currency module 204 can provide the content by evaluating: 1) a user's affiliation to a community, 2) listening to conversations and interactions among individuals, 3) through group and information sharing, 4) through monitoring for advocating related to a brand, and 5) detecting knowledge sharing in a given area. Evaluating the user and content using the social currency elements mentioned provides the opportunity to identify the user, analyze their social behavior, and engage them, to influence a successful outcome. The social currency module 204 can work in conjunction with the analytics module 206 and data tracker 208 to listen, monitor, analyze, and categorize the media data to deliver insights via platforms on a dashboard and/or via reports. In some embodiments, the augmented media system 202 operates in real-time by scraping social media and analyzing the digital data for the presentation in an organized report, dashboard, or other platform.

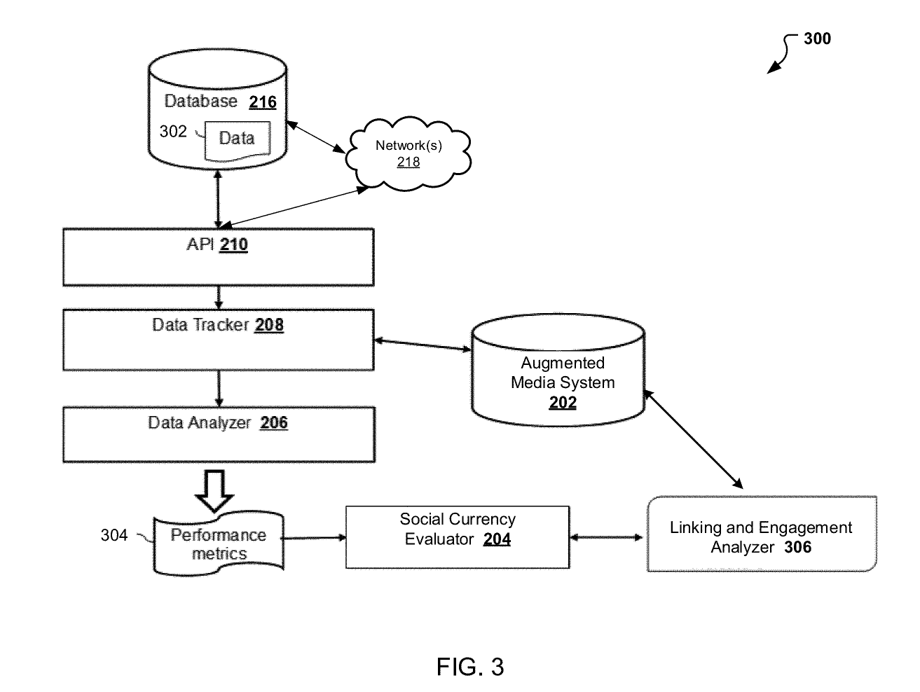

FIG. 3 presents the process for the augmented media system 202 as a technical solution and media platform designed to provide content in a time sensitive manner. In particular, FIG. 3 illustrates a system 300 for the monitoring and analysis performed using augmented media intelligence. As previously indicated, the media data 302 may arrive from external sources and/or peripherals 220-224 via one or networks 218 which scrape and ingest data regarding a particular company, platform, campaign, product, etc., of interest. In some instances, the media data 302 obtained is classified and stored in a database 216 for performing the data analytics, and for building machine learning algorithms for deeper insights. In some instances, the media data 302 may be stored in database 216 and classified into a corresponding library based on the content. In other instances, database 216 may also be used to store other enterprise business data which can be relevant in the data analytics resulting from machine learning co-relation and causation discovery. For example, key performance indicators (KPIs) may be stored and used during the data analytics in conjunction with artificial intelligence and algorithms to determine the impact by the media. Classification and data analytics may be performed using statistical models, neural networks, and other machine learning algorithms where trends, graphs, and correlations can be obtained.

As illustrated in FIG. 3, the media data 302 stored and/or retrieved may proceed to an application programming interface 210 where the database 216 and external devices can interact with the augmented media system 202. The API 210 can simultaneously communicate with at least the data tracker 208. Further, the APIs can be used to build a user experience and solution on the platform. The API 210 also communicates with at least a data tracker 208. As previously indicated, the API 210 can enable the data tracker module 208 to retrieve data from database nodes, servers, and external devices, and/or monitor movements of the data across the database nodes and other media data deriving from the network(s) 218. The data tracker 208 enables the ability to track influencers and others who can impact a company, brand, sentiment, or the like and allows the opportunity to manage those making an impact pro-actively to deliver value. Monitoring and listening via the data tracker also provides groups within an organization, for example, a communications team, with insight and analysis of the media data 302 via a media platform.

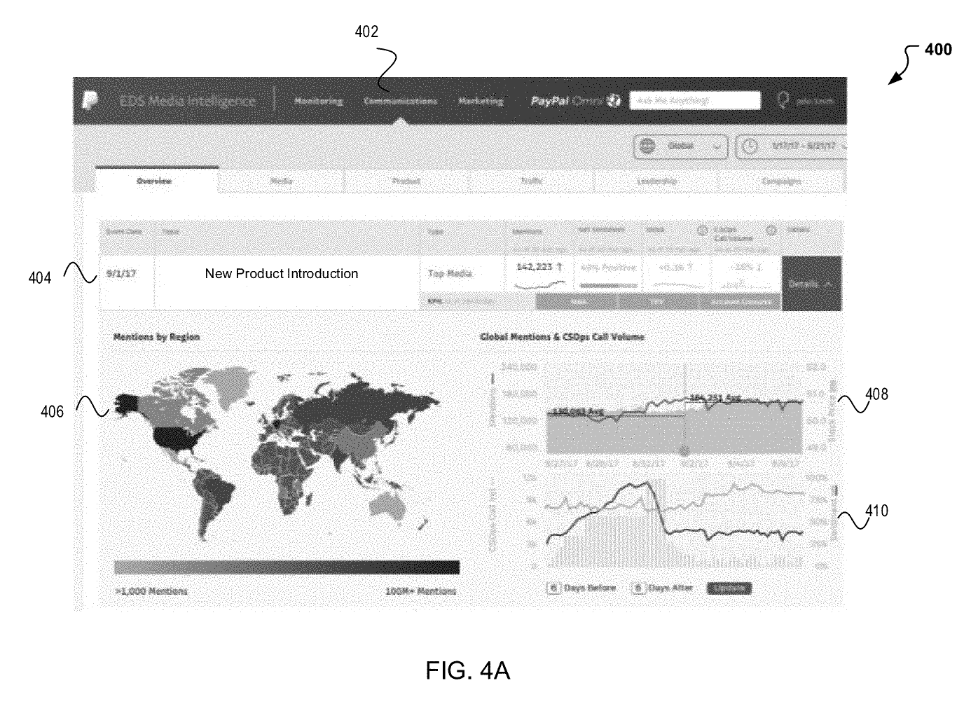

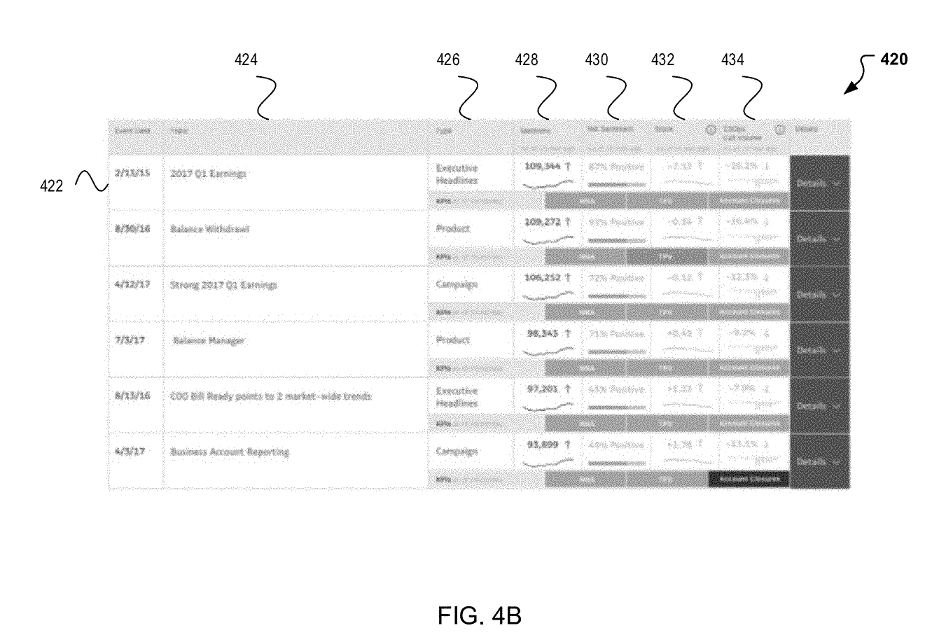

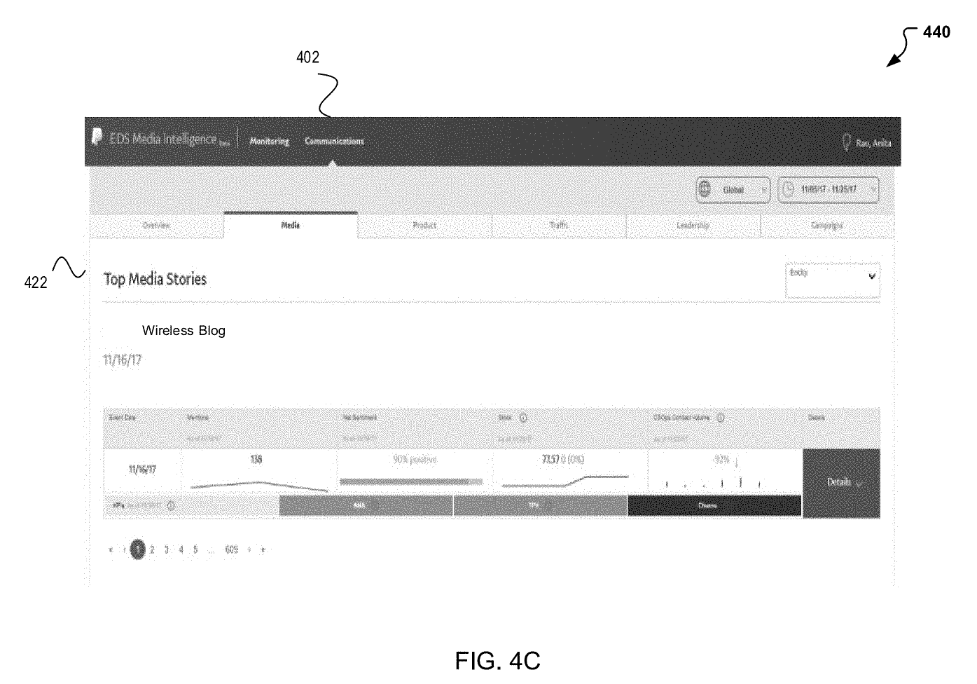

Following data tracking, the system 300 may continue to the data analysis portion of the process of computing the analytics desired by a team, organization, group, individual, corporation or the like. As indicated, data analyzer 206 (e.g., analytics module 206) can be designed to perform the real-time analytics desired in a platform designed for augmented media intelligence. In particular, descriptive analytics 102, diagnostics analytics 104, predictive analytics 106, prescriptive analytics and cognitive analytics 107 can occur on the analytics module 206 for monitoring, responding, predicting and prescribing how to respond to a campaign, event, feedback, etc. To perform such analytics, the data analyzer 206 may include an artificial intelligence engine with natural language processing capabilities in order to respond to complex queries. Additionally, statistical analytical models may also be used in such analytics. For example, the statistical analytical models may be used to identify trends and/or locate outliers. In addition, the data analyzer 206 may be used in conjunction with the data tracker 208 for trends and correlations between media data 302 posts such that the data collected may be used to predict future behaviors and/or plan future media events. Such events, data trends may be used in performance metrics 304, where the performance metrics may then be used to proactively generate one or more performance reports for presentation in response to a user request. For example, the generated performance reports may be presented on a dashboard interface. Since the performance reports are generated based on real-time tracking of data, users may confidently use the information presented in the reports to make decisions. Further, a query may be generated to retrieve the data and associated performance metrics corresponding to one or more domains within the enterprise system, and another query may be generated to retrieve the data and associated performance metrics corresponding to one or more work flows defined by the augmented media system 300. In response to the query, the data may be retrieved from the database 216 and/or other external sources and presented in an interactive user interface to the user making the request. In some embodiments, the data may be presented in the form of a graph, statistics, maps, and other relevant diagrams based on the criteria specified by the user. FIGS. 4A-4C include exemplary interactive interfaces that may be used in the presentation of such data. These exemplary interactive interfaces will be described in more detail below and in conjunction with FIGS. 4A-4C.

In some embodiments, a social currency evaluator 204 may be part of the process in system 300. The social currency evaluator 204 can be used to provide personalized content in real-time to a user. In some instances, the social currency evaluator 204 may arrive after the performance metrics are received to provide added detail on individual's behaviors and propensity to engage in an event. The social currency evaluator 204 can further be used for profile stitching, analyzing social behaviors, and engaging key individuals to influence successful outcomes. Therefore, understanding the individual's social currency can then be used by a linking and engagement analyzer 306 for linking the behaviors with the groups and engaging with them to impact business key performance indicators. In other instances, the social currency evaluator 204 may be used prior to the performance metrics in order to perform personalized performance metrics to the user. For example, the social currency evaluator 204 may be used to present graphs and other relevant information to the user in the form of the interactive user interfaces tailored to present the data most relevant to the individual and/or audience. Therefore, the data received, metrics collected, and social currency determined, may be feedback to the augmented media system 202 in order to provide learned and more accurate assessments. The system 300 has a feedback loop that can create a constant stream of self-reinforcing activity.

To illustrate an exemplary process of how an organization flow may run using system 300, consider a marketing group within an organization. The marketing group may use an augmented media system 202 to determine how to best market a new product for release. Concurrently, digital media is continually monitored for relevant events and possible crisis. The crises identified can then be addressed through close assessment. The assessment can include understanding the crisis by region, timing, sentiments, etc. so that proper personalized stitching and engagement may occur with key influencers in an effort to minimize the impact business KPIs. Note that the analysis and assessments performed throughout the process occurs using any combination of statistical models, natural language processing, and artificial intelligence. The data analytics, as indicated above, can include the use of diagnostic analytics, predictive, prescriptive and cognitive analytics.

During the tracking and monitoring of the content, interactive user interfaces may be used for the presentation of the information. FIGS. 4A-4C provide data visualizations for augmented media intelligence. In particular, FIGS. 4A-4C illustrate exemplary interactive user interfaces that may be presented to a user of the augmented media system 202. Turning to FIG. 4A, a first exemplary interactive user interface 400 is presented. The first exemplary interactive user interface 400 illustrates a page on a dashboard of the augmented media system 202 designed for a communication team. In this exemplary example, the team member has selected the option to obtain an overview of the digital media current status regarding a new product introduction 424. In this environment, the user is interested in obtaining details of impact on regional 406, stock 408, and sentiment 410 regarding this new product that was introduced on September 1. Additionally, a rollup of the event can be presented in a table like manner adjacent to the product release or topic of interest. For example, in this instance, the user opted to obtain details regarding the number of mentions, the overall sentiment, and the stock price on the date of the new product introduction 424. Alternatively, the user may have desired to obtain other details regarding purchases, manufacturing capacity, or other relevant information to the topic of interest. Obtaining this detail, the communications team can user the augmented media system 202 to perform other data analytics including predictive and prescriptive analysis useful in future product introductions and customer experiences. For example, a next product introduction can manage its campaign and marketing such that those regions with fewer mentions and/or lower sentiments are addressed.

Next, turning to FIG. 4B, a second exemplary interactive user interface 420 is illustrated. Second exemplary interactive user interface 420 provides a snapshot of a tailored response to a specific query request by the user. In this interactive user interface 420, a table is presented summarizing a series of significant events that have occurred over the course of almost two years. Each event is presented in a row 422 with corresponding parameters summarizing the type of event 426, stock price 432, mentions 428, sentiments 430, Val volume (service call volume) 434, etc. on the date of the event. Again, this interactive user interface 420 is designed to provide some illustrative examples of the type and format of information that is available in real-time through the use of the augmented media system 202. In addition, note that the categories summarized are adaptable to the needs of the individual and/or organization and can be either predetermined by the system and/or adapted/selected by the user.

Another example of media intelligence available to the user is presented in FIG. 4C. In particular, FIG. 4C illustrates a third exemplary interactive user interface 440 that may be available on a dashboard platform to a communications group 402 within an organization or corporation. The third exemplary interactive user interface 440 provides a third example of information and interface available via the augmented media system 202 through its communication with external networks, peripherals, and databases. In this instance, the interactive interface 440 was selected to present information regarding media and in particular a current top media stories 422. Presented here is the media response to a wireless blog posting on November 16 of this year. As in the other user interfaces 400,420, this user interface 420 also presents a summary of mentions, sentiments, stock price, etc. related to the wireless blog post and of interest to the communications organization. Note that although stock price, mentions, and sentiments are generally illustrated throughout, other categories, may be displayed based on the goal and information relevant to the user. Also note that although the interactive user interfaces presented above and in conjunction with FIGS. 4A-4C, such customized information is available to other organizations. For example, a marketing group may benefit obtaining user mentions on a previous product to market a new campaign or track a product performance. As another example, the marketing group may use the augmented media system 202 to aid in determining how to publish content across social media channels driving a campaign.

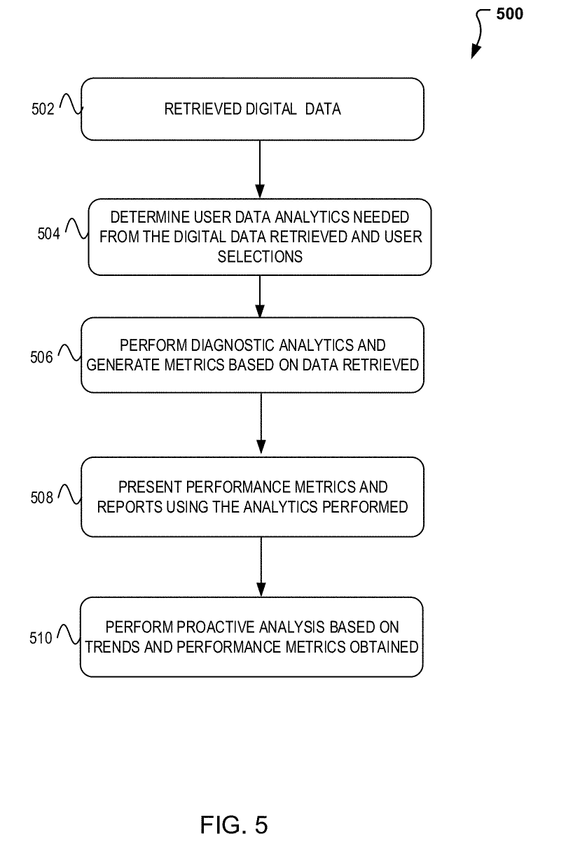

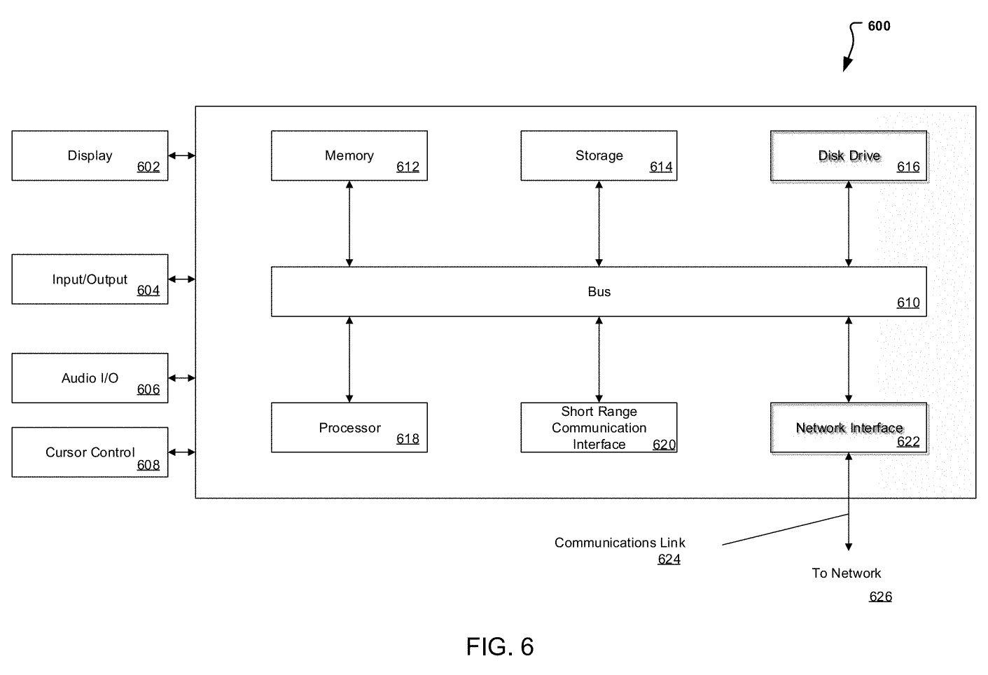

To illustrate how the interactive user interfaces and overall augmented media system 202 may be used, FIG. 5 is introduced which illustrates example process 500 that may be implemented on a system 600 of FIG. 6. In particular, FIG. 5 illustrates a flow diagram illustrating how an augmented media system provides data analytics and visualization using digital media. According to some embodiments, process 500 may include one or more of operations 502-510, which may be implemented, at least in part, in the form of executable code stored on a non-transitory, tangible, machine readable media that, when run on one or more hardware processors, may cause a system to perform one or more of the operations 502-510.

Process 500 may begin with operation 502, where data is retrieved. As previously indicated, large data is constantly collected by devices, through networks, external peripherals and other means. The data received, scraped, and gathered is received and/or retrieved, then cleansed, transformed and loaded in a data model designed and built for this system in some instances stored for later use. This data retrieved in real-time and/or retrieved from a database is collected oftentimes needs to be organized and analyzed. If a latency exists in providing the real-time data, it may be adjusted in demand, and in some instances due to the use case being analyzed. For example, the data retrieved can include media posts, mentions, views, comments, page views, and the like, can be analyzed to decipher what happened based on the data retrieved.

At operation 504, determining what happened based on the data occurs. In particular, at operation 504, user data analytics needed from the digital data retrieved is determined. As indicated, an interaction user interface is available to a user and as such in determining what data analytics is to be performed, user input is oftentimes considered. Alternatively, based on the digital data retrieved the augmented media system 202 can determine what diagnostic analytics to perform. Diagnostic analytics are useful in determining why an event, response, comment, or other occurred. Diagnostic analytics involves learning based on the monitoring why a result occurred and what did/did not work. Because the analytics includes learning from the data retrieved, machine learning algorithms and even statistics are used in determining correlations between the data retrieved including correlations between media sentiments and the business impact on key performance indicators (KPIs) and other data of interest. At operations 506 and 508, the diagnostic analytics are performed and performance metrics are generated based on the analytics determined to be performed and presented. At operation 508, the performance metrics presented can be in the form of graphs, maps, statistics, and other relevant forms of visualization data. For the presentation, an interactive user interface may be used as described above and in conjunction with FIGS. 4A-4

In response to the information presented at operation 508, users including organizations, teams, corporations and other interested parties can use the augmented media system to perform further data analysis useful in strategy, marketing, product releases, and the like. Therefore, at operation 510, proactive analysis based on the trends and performance metrics obtained are performed. Predictive media analysis is the analysis of the data retrieved to predict future events. For example, predictive analytics may be used to predict the media impact of a given campaign. That is to say, using historical data, media responses, and large data analysis, predictions can be made as to how a product release, posts, announcements, or campaigns will be received. Additionally or alternatively, prescriptive analytics can also be performed, which extend the analysis of historical trends from the data retrieved to discover trends and patterns in the data. The patterns and trends identified can then be used to provide insights and/or prescribe future events, responses, postings, etc. For example, prescriptive analysis may be used to recommend a future campaign for the business. As such, additional visual representations may be presented to the user on the interactive user interface. As indicated, the visual representations can come in the form of a report, graph, or other useful metric representation. Note that although maps, graphs, and averages are described herein and illustrated in conjunction with FIGS. 4A-4C, other useful visual representation is possible including but not limited to common errors encountered, broken links needed repair, and other media feedback applicable to an organization and enterprise media data system. In addition, note that the user social currency may be considered during one or more of the system operations in order to provide a tailored visual representation based on the user's affiliations, interactions, knowledge sharing, etc. In general, social currency can be described as the response and resources that arise from content and information shared about a brand or other through social networks, communities, and other social media. Therefore, the social currency can be used, for example after operation 508 and/or 510 in order to provide a real-time personalized content to help increase a user's propensity to engage in a purchase or respond to a product, campaign, or other.

FIG. 6 illustrates an example computer system 600 in block diagram format suitable for implementing on one or more devices of the system in FIGS. 1-5 and in particular augmented media system 202. In various implementations, a device that includes computer system 600 may comprise a personal computing device (e.g., a smart or mobile device, a computing tablet, a personal computer, laptop, wearable device, PDA, etc.) that is capable of communicating with a network 626. A service provider and/or a content provider may utilize a network computing device (e.g., a network server) capable of communicating with the network. It should be appreciated that each of the devices utilized by users, service providers, and content providers may be implemented as computer system 600 in a manner as follows.

Additionally, as more and more devices become communication capable, such as new smart devices using wireless communication to report, track, message, relay information and so forth, these devices may be part of computer system 600. For example, windows, walls, and other objects may double as touch screen devices for users to interact with. Such devices may be incorporated with the systems discussed herein.

Computer system 600 may include a bus 610 or other communication mechanisms for communicating information data, signals, and information between various components of computer system 600. Components include an input/output (I/O) component 604 that processes a user action, such as selecting keys from a keypad/keyboard, selecting one or more buttons, links, actuatable elements, etc., and sending a corresponding signal to bus 610. I/O component 604 may also include an output component, such as a display 602 and a cursor control 608 (such as a keyboard, keypad, mouse, touchscreen, etc.). In some examples, I/O component 604 other devices, such as another user device, a merchant server, an email server, application service provider, web server, a payment provider server, and/or other servers via a network. In various embodiments, such as for many cellular telephone and other mobile device embodiments, this transmission may be wireless, although other transmission mediums and methods may also be suitable. A processor 618, which may be a micro-controller, digital signal processor (DSP), or other processing component, that processes these various signals, such as for display on computer system 600 or transmission to other devices over a network 626 via a communication link 624. Again, communication link 624 may be a wireless communication in some embodiments. Processor 618 may also control transmission of information, such as cookies, IP addresses, images, and/or the like to other devices.

Components of computer system 600 also include a system memory component 614 (e.g., RAM), a static storage component 614 (e.g., ROM), and/or a disk drive 616. Computer system 600 performs specific operations by processor 618 and other components by executing one or more sequences of instructions contained in system memory component 612 (e.g., for engagement level determination). Logic may be encoded in a computer readable medium, which may refer to any medium that participates in providing instructions to processor 618 for execution. Such a medium may take many forms, including but not limited to, non-volatile media, volatile media, and/or transmission media. In various implementations, non-volatile media includes optical or magnetic disks, volatile media includes dynamic memory such as system memory component 612, and transmission media includes coaxial cables, copper wire, and fiber optics, including wires that comprise bus 610. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, hard disk, magnetic tape, any other magnetic medium, CD-ROM, any other optical medium, RAM, PROM, EPROM, FLASH-EPROM, any other memory chip or cartridge, or any other medium from which a computer is adapted to read.

Components of computer system 600 may also include a short range communications interface 520. Short range communications interface 620, in various embodiments, may include transceiver circuitry, an antenna, and/or waveguide. Short range communications interface 620 may use one or more short-range wireless communication technologies, protocols, and/or standards (e.g., WiFi, Bluetooth®, Bluetooth Low Energy (BLE), infrared, NFC, etc.).

Short range communications interface 620, in various embodiments, may be configured to detect other devices (e.g., device 102, secondary user device 104, etc.) with short range communications technology near computer system 600. Short range communications interface 620 may create a communication area for detecting other devices with short range communication capabilities. When other devices with short range communications capabilities are placed in the communication area of short range communications interface 620, short range communications interface 620 may detect the other devices and exchange data with the other devices. Short range communications interface 620 may receive identifier data packets from the other devices when in sufficiently close proximity. The identifier data packets may include one or more identifiers, which may be operating system registry entries, cookies associated with an application, identifiers associated with hardware of the other device, and/or various other appropriate identifiers.

In some embodiments, short range communications interface 620 may identify a local area network using a short range communications protocol, such as WiFi, and join the local area network. In some examples, computer system 600 may discover and/or communicate with other devices that are a part of the local area network using short range communications interface 620. In some embodiments, short range communications interface 620 may further exchange data and information with the other devices that are communicatively coupled with short range communications interface 620.

In various embodiments of the present disclosure, execution of instruction sequences to practice the present disclosure may be performed by computer system 600. In various other embodiments of the present disclosure, a plurality of computer systems 600 coupled by communication link 624 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the techniques and algorithms described herein.

A computer system may transmit and receive messages, data, information and instructions, including one or more programs (i.e., application code) through a communication link 624 and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable media. It is also contemplated that software identified herein may be implemented using one or more computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on the user and user device, however, a customer, a merchant, a service or payment provider may otherwise presented with tailored information. Thus, “user” as used herein can also include charities, individuals, and any other entity or person receiving information. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing instructions; and
a processor configured to execute instructions to cause the system to:
in response to a determination that new data is available for processing, retrieve real-time digital data;
determine a combination of data analytics to be performed based in part on the digital data and user preferences;
calculate, the combination of data analytics the data analytics including diagnostic analytics, wherein the data analytics uses a machine learning algorithm to determine a reason for a first event occurrence;
generate, a performance metric and report using the diagnostic analytics performed; and
calculate, using a machine learning technique, proactive analytics to predict a second event base in part on the first event occurrence.

2. The system of claim 1, executing instructions further causes the system to:
calculate, using the machine learning technique, prescriptive analytics to determine historical trends in the digital data from the first event.

3. The system of claim 1, executing instructions further causes the system to:
generate a second report using the proactive analytics calculated.

4. The system of claim 1, wherein the reason for the event occurrence is determined based on a monitoring of the real-time digital data.

5. The system of claim 1, wherein the diagnostic analytics includes determining a correlation between media sentiments and a business key performance indicator.

6. The system of claim 1, wherein the performance metric and report are transmitted, via network connection, to a user device for presentation on an interactive user interface.

7. The system of claim 6, wherein the performance metric and the report transmitted is personalized using a social currency of the user of the user device.

8. A method comprising:
in response to a determination that new data is available for processing, retrieving a real-time digital data;
determining a combination of data analytics to be performed based in part on the digital data and user preferences;
calculating, the combination of data analytics the data analytics including diagnostic analytics, wherein the data analytics uses a machine learning algorithm to determine a reason for a first event occurrence;
generating, a performance metric and report using the diagnostic analytics performed; and
calculating, using a machine learning technique, proactive analytics to predict a second event base in part on the first event occurrence.

9. The method of claim 8, further comprising:
calculating, using the machine learning technique, prescriptive analytics to determine historical trends in the digital data from the first event.

10. The method of claim 8, further comprising:
generating a second report using the proactive analytics calculated.

11. The method of claim 8, wherein the reason for the event occurrence is determined based on a monitoring of the real-time digital data.

12. The method of claim 8, wherein the diagnostic analytics includes determining a correlation using machine learning between media sentiments and a business key performance indicator.

13. The method of claim 8, wherein the performance metric and report are transmitted, via network connection, to a user device for presentation on an interactive user interface.

14. The method of claim 13, wherein the performance metric and the report transmitted is personalized using a social currency of the user of the user device.

15. A non-transitory machine readable medium having stored thereon machine readable instructions executable to cause a machine to perform operations comprising:
in response to a determination that new data is available for processing, retrieving real-time digital data;
determining a combination of data analytics to be performed based in part on the digital data and user preferences;
calculating, the combination of data analytics the data analytics including diagnostic analytics, wherein the data analytics uses a machine learning algorithm to determine a reason for a first event occurrence;
generating, a performance metric and report using the diagnostic analytics performed; and
calculating, using a machine learning technique, proactive analytics to predict a second event base in part on the first event occurrence.

16. The non-transitory medium of claim 15, further comprising:
calculating, using the machine learning technique, prescriptive analytics to determine historical trends in the digital data from the first event.

17. The non-transitory medium of claim 15, further comprising:
generating a second report using the proactive analytics calculated.

18. The non-transitory medium of claim 15, wherein the reason for the event occurrence is determined based on a monitoring of the real-time digital data.

19. The non-transitory medium of claim 15, wherein the performance metric and report are transmitted, via network connection, to a user device for presentation on an interactive user interface.

20. The non-transitory medium of claim 19, wherein the performance metric and the report transmitted is personalized using a social currency of the user of the user device.
